(19) United States
(12) Patent Application Publication
(10) Pub. No.: US 2022/0299088 A1
(43) Pub. Date: Sep. 22, 2022

(54) Gear assembly, transmission mechanism and electric drill

(71) Applicant: Globe (Jiangsu) Co., Ltd., Changzhou (CN)

(72) Inventor: Fei Huang, Changzhou (CN)

(73) Assignee: Globe (Jiangsu) Co., Ltd., Changzhou (CN)

(21) Appl. No.: 17/695,822

(22) Filed: Mar. 15, 2022

(30) Foreign Application Priority Data
Mar. 17, 2021 (CN) 202120550006.1

(51) Int. Cl. F16H 1/46; E21B 7/02; F16H 57/04

(52) U.S. Cl. CPC F16H 1/46; E21B 7/028; F16H 57/045

(57) ABSTRACT

The disclosure provides a gear assembly, a transmission mechanism and an electric drill. The transmission mechanism includes a sun gear, a planetary gear assembly and an output shaft. The sun gear is arranged on a motor output shaft of a driving motor. The planetary gear assembly includes a planet carrier and a planetary gear. The planetary gear is arranged on one side of the planet carrier and meshing with the sun gear. A shaft hole is arranged on a gear in the planetary gear. A gear shaft is mounted in the shaft hole. One end of the gear shaft is connected with the planet carrier. An inner wall of the shaft hole being provided with a helical groove to store lubricant. The output shaft is fixedly connected with a side of the planetary gear away from the planet carrier.

### CROSS REFERENCE TO RELATED APPLICATION

The present application is based on, and claims the priority from, Chinese application number CN 202120550006.1, filed on Mar. 17, 2021, the disclosure of which is hereby incorporated by reference herein in its entirety.

### TECHNICAL FIELD

The disclosure relates to the technical field of power tools, in particular to a gear assembly, a transmission mechanism and an electric drill.

### BACKGROUND

Electric drills are widely used in sloping, sandy, and hard soil for seedling landscaping projects to plant and dig pits, and excavate the periphery of large trees. However, in the conventional electric drill transmission structure, in a matching part between the planetary gear and the output shaft pin, the shaft-hole fit method is often used, and the clearance is properly reserved to achieve a purpose of a clearance fit. In order to improve the lubrication state of the shaft hole, it is only possible to appropriately increase the fit clearance, but this will affect the positioning accuracy of the planetary gear. And since the secondary planetary gear will bear a large load, eventually a large pressure will be generated between the planetary gear hole and the output shaft pin. In a presence of oil film, it can work normally under a large load. If after a period of use, due to the large pressure and small clearance fit, the oil film between the pin and the gear hole is damaged and not replenished in time, which will cause a metal dry grinding under an action of the large load to further deteriorate the oil film, and eventually a failure of the gear hole and the output shaft pin due to a gluing by the deteriorated oil.

### SUMMARY

The disclosure provides a gear assembly, a transmission mechanism and an electric drill. The transmission mechanism is driven by a gear set, and a helical groove is arranged on an inner wall of a shaft hole of a gear to store lubricant.

The disclosure provides a gear assembly. The gear assembly includes the gear and a gear shaft. The gear is provided with the shaft hole. The gear shaft is mounted in the shaft hole. An inner wall of the shaft hole is provided with a helical groove to store lubricant.

The disclosure provides a transmission mechanism. The transmission mechanism includes a sun gear, a planetary gear assembly and an output shaft. The sun gear is arranged on a motor output shaft of a driving motor. The planetary gear assembly includes a planet carrier and a planetary gear. The planetary gear is arranged on a side of the planet carrier and meshing with the sun gear. A shaft hole is arranged on a gear in the planetary gear. A gear shaft is mounted in the shaft hole. An end of the gear shaft is connected with the planet carrier. An inner wall of the shaft hole is provided with a helical groove to store lubricant. The output shaft is connected with a side of the planetary gear away from the planet carrier.

In an embodiment of the disclosure, the transmission mechanism further includes an inner ring gear. The planetary gear is located in the inner ring gear and meshes with the inner ring gear.

In an embodiment of the disclosure, the transmission mechanism further includes a gearbox. The planetary gear assembly and the inner ring gear are located in the gearbox, and the inner ring gear is connected with an inner wall of the gearbox.

In an embodiment of the disclosure, one end of the output shaft is fixedly connected with a bottom of the planet carrier, and the other end of the output shaft is connected with a drill rod assembly.

In an embodiment of the disclosure, the end of the output shaft connected with the planet carrier is provided with a counterbore, and the counterbore and a center hole of the planet carrier are located on a same axis.

In an embodiment of the disclosure, a positioning pin is arranged in the counterbore, and an end of the positioning pin protrudes out of the counterbore and extends into the center hole of the planet carrier to ensure a coaxial rotation of the planet carrier and the output shaft.

In an embodiment of the disclosure, the sun gear includes at least a first sun gear and a second sun gear, and the planetary gear assembly includes at least a first planetary gear assembly and a second planetary gear assembly.

In an embodiment of the disclosure, the first sun gear is arranged on the motor output shaft, the first planetary gear assembly is meshed with the first sun gear through a first planetary gear to transmit, a bottom of the first planetary gear assembly is connected with the second sun gear, the second planetary gear assembly is meshed with the second sun gear through a second planetary gear to transmit, and the output shaft is connected with a bottom of the second planetary gear assembly.

In an embodiment of the disclosure, the first planetary gear assembly further includes at least two sets of first planetary gears, and the at least two sets of the first planetary gears are arranged and overlapped along an axial direction of the inner ring gear.

In an embodiment of the disclosure, each set of the first planetary gears includes a plurality of gears, the plurality of the gears are evenly distributed around the first sun gear and meshed with the first sun gear to transmit, and the plurality of the gears are located on a same horizontal plane.

In an embodiment of the disclosure, the sun gear is fixedly connected with the motor output shaft of the driving motor or the sun gear and the motor output shaft of the driving motor are integrally formed.

The disclosure further provides an electric drill. The electric drill includes a supporting assembly, a handle assembly, a driving assembly and a drill rod assembly. The supporting assembly includes a supporting plate and a bracket, and the supporting plate is mounted on the bracket. The handle assembly is arranged on a handle of the bracket. The driving assembly is arranged on the supporting plate. The driving assembly includes a driving motor and a transmission mechanism. The transmission mechanism is connected with a motor output shaft of the driving motor. The transmission mechanism includes a sun gear, a planetary gear assembly and an output shaft. The sun gear is arranged on the motor output shaft of the driving motor. The planetary gear assembly includes a planet carrier and a planetary gear, the planetary gear is arranged on a side of the planet carrier and meshes with the sun gear, a shaft hole is arranged on a gear in the planetary gear, a gear shaft is mounted in the shaft hole, an end of the gear shaft is connected with the planet carrier, and an inner wall of the shaft hole is provided with a helical groove to store lubricant. The output shaft is connected with a side of the planetary gear away from the planet carrier. The drill rod assembly is connected with the output shaft in the transmission mechanism.

The disclosure provides the gear assembly, the transmission mechanism and the electric drill. Through machining the helical groove in the inner hole of the gear in a planetary transmission, a storage of lubricant may be achieved, so as to increase a duration life of a transmission structure, especially in a heavy-duty transmission structure, which improves the lubrication condition.

### BRIEF DESCRIPTION OF THE DRAWINGS

In order to explain technical solutions of embodiments of the disclosure more clearly, the following will briefly introduce drawings used in the description of the embodiments or prior art. Obviously, the drawings in the following description are only some embodiments of the disclosure. For those of ordinary skill in the art, other drawings may be obtained based on these drawings without creative work.

FIG. 1 is a schematic structural view of an overall structure of an electric drill according to an embodiment of the disclosure.

FIG. 2 is a schematic structural view of a supporting assembly.

FIG. 3 is a schematic structural view of part of the structure of the electric drill.

FIG. 4 is a schematic cross-sectional structure view of FIG. 3.

FIG. 5 is a schematic cross-sectional structure view of a driving assembly.

FIG. 6 is an exploded schematic structural view of the driving assembly.

FIG. 7 is a schematic structural view of a gear.

### PART NUMBER DESCRIPTION

10—supporting assembly, 11—supporting plate, 12—bracket, 111—through hole, 112—moment bearing component, 121—main arm, 122—handle, 1221—handle grip, 20—handle assembly, 30—drill rod assembly, 40—driving assembly, 41—driving motor, 411—heat dissipation blade, 42—housing, 421—accomondating cavity, 422—battery groove, 423—partition, 43—air guiding cover, 44—gearbox, 45—output shaft, 451—counterbore, 452—positioning pin, 46—connecting base, 47—bearing, 471—first bearing, 472—second bearing, 48—bearing base, 4212—air outlet cavity, 431—arc guiding wall, 31—drill rod, 32—splitter plate, 311—drill shaft, 312—double auger blade, 491—first planetary gear, 492—inner ring gear, 493—first sun gear, 494—first planet carrier, 495—first gear shaft, 496—second planetary gear, 497—second sun gear, 498—second planet carrier, 499—second gear shaft, 401—helical groove.

### DETAILED DESCRIPTION

The following describes the implementation of the disclosure through specific embodiments, and those skilled in the art can easily understand other advantages and effects of the disclosure from the content disclosed in this specification. The disclosure can also be implemented or applied through other different specific embodiments, and various details in this specification can also be modified or changed based on different viewpoints and applications without departing the disclosure.

It should be noted that the figures provided in this embodiment only illustrate the basic idea of the disclosure in a schematic manner. The figures only show the components related to the disclosure instead of drawing according to the number, shape and size of the components during actual implementation. The type, number and proportion of each component during actual implementation can be changed at will, and the layout of its components may also be more complicated.

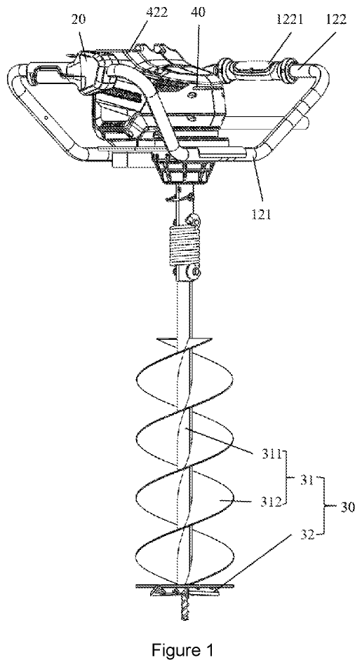

In order to solve problems of poor positioning accuracy and low duration life of the planetary gear, the disclosure provides a transmission assembly for an electric drill. Please refer to FIG. 1. The electric frill includes a supporting assembly 10, a handle assembly 20, a drill rod assembly 30 and a driving assembly 40. The driving assembly 40 includes a driving motor 41 and the transmission assembly mentioned above. The transmission assembly includes a gear assembly. The gear assembly includes a gear and a gear shaft. The gear is provided with a shaft hole. The gear shaft is mounted in the shaft hole. An inner wall of the shaft hole is provided with a helical groove to store lubricant.

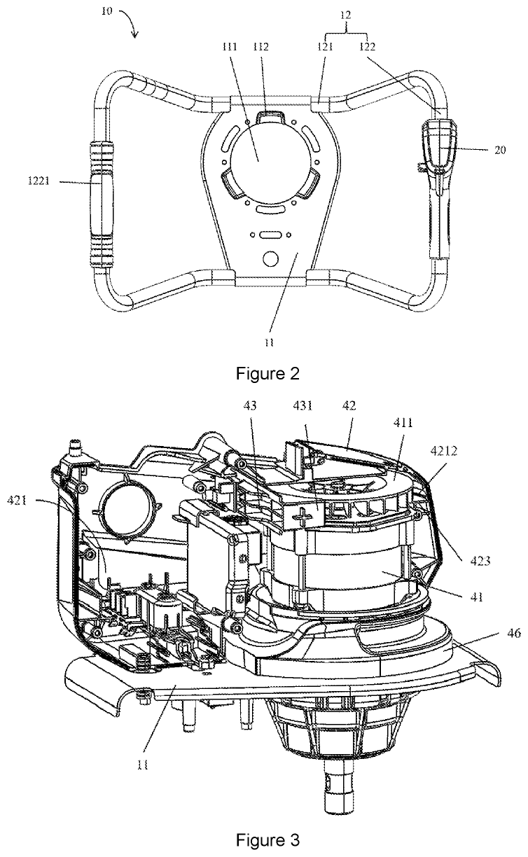

Please refer to FIG. 1 and FIG. 2. In an embodiment of the disclosure, the supporting assembly 10 includes a supporting plate 11 and a bracket 12. The supporting plate 11 is fixedly mounted on the bracket 12. The supporting plate 11 is provided with a through hole 111 matched with the driving assembly 40 and a moment bearing component 112. The moment bearing components 112 are evenly distributed and arranged along a periphery of the through hole 111 to bear a moment transmitted by the driving assembly 40 to the supporting plate 11. A quantity of the moment bearing components 112 may be set as required. When the number of the moment bearing components 112 is multiple, the moment bearing components 112 are evenly distributed and arranged on the periphery of the through hole 111, so that each of the moment bearing components 112 may bear substantially equal moments, thereby effectively preventing some moment bearing components 112 from being easily damaged due to an uneven bearing of the moment. The bracket 12 includes a main arm 121 and a handle 122. The handle 122 is defined through bending and extending from both sides of the main arm 121. The handle assembly 20 is mounted on the handle 122. The supporting plate 11 is fixedly mounted on the main arm 121 by screws. In an embodiment, a handle grip 1221 is arranged on the handle 122 to improve a user's feeling.

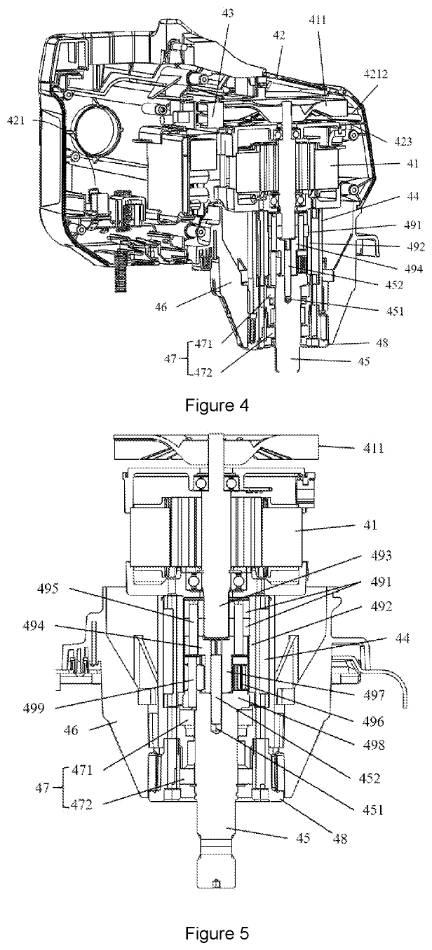

Please refer to FIG. 3 and FIG. 4. In an embodiment of the disclosure, the drill rod assembly 30 is mounted on the driving assembly 40. The drill rod assembly 30 is driven to work by the driving assembly 40, and the driving assembly 40 is fixedly mounted on the supporting plate 11. The driving assembly 40 includes a driving motor 41, a housing 42, an air guiding cover 43, a gearbox 44, an output shaft 45, a connecting base 46, a bearing 47, a bearing base 48 and a transmission mechanism. The housing 42 is fixedly mounted on the supporting plate 11 by screws, and matched with the connecting base 46 to define an accommodating cavity 421. The accommodating cavity 421 is configured to accommodate the driving motor 41, the air guiding cover 43 and the gearbox 44. The housing 42 is provided with a battery groove 422 and a partition 423. The battery groove 422 is configured to accommodate a battery assembly, and the battery groove 422 is located on a side of the driving motor 41 close to the user to supply power for the electric drill. The partition 423 abuts against a motor casing of the driving motor 41 and is matched with the air guiding cover 43 in order to divide the accommodating cavity 421 into an air inlet cavity and an air outlet cavity 4212. An end of the driving motor 41 is provided with a heat dissipation blade 411 away from the connection base 46. The heat dissipation blades 411 is housed in the air outlet cavity 4212. A rest of the driving motor 41 except the heat dissipation blade 411 and the gearbox 44 are housed in the air inlet cavity. In the embodiment, an arc guiding wall 431 is arranged on a side of the air guiding cover 43 facing the driving motor 41 to smoothly guide hot air to be discharged from the heat dissipation blades 411 to an outside of the air outlet cavity 4212, and reduce an air resistance of the hot air in the air outlet cavity 4212. One end of the gearbox 44 is matched with the driving motor 41, and the other end of the gearbox 44 is matched with the output shaft 45 of the transmission mechanism, so as to transmit a power output by the driving motor 41 to the output shaft 45 of the transmission mechanism. Please refer to FIG. 0.1. In an embodiment of the disclosure, the drill rod assembly 30 includes a drill rod 31 and a splitter plate 32. The drill rod 31 includes a drill shaft 311 mounted on the driving assembly 40 and a double auger blade mounted on the drill shaft 311. In the embodiment, the bearing 47 is sleeved on the output shaft 45 and includes a first bearing 471 located in the gearbox 44 and a second bearing 472 located in the bearing base 48. The output shaft 45 passes through the first bearing 471, the second bearing 472 and the bearing base 48, and protrudes out of the bearing base 48 to be matched with the drill rod assembly 30. Since the first bearing 471 is arranged in the gearbox 44 and the second bearing 472 is arranged in the bearing base 48, a distance between the first bearing 471 and the second bearing 472 may be maximized, thereby effectively ensuring an output coaxiality of the output shaft 45.

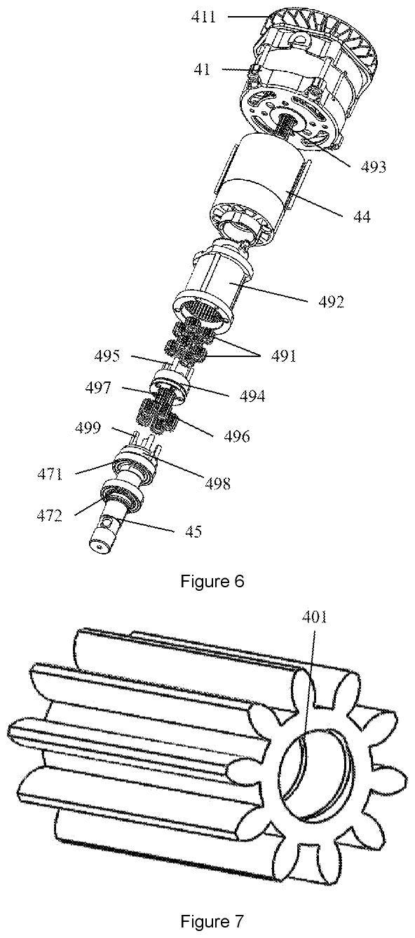

Please refer to FIG. 4 through FIG. 6. The disclosure provides the transmission mechanism, the transmission mechanism is used for the electric drill. In an embodiment of the disclosure, the transmission mechanism includes a sun gear, a planetary assembly and an output shaft. The sun gear is arranged on the motor output shaft of the driving motor. The planetary gear assembly includes a planet carrier and a planetary gear. The planetary gear is arranged on one side of the planet carrier and meshes with the sun gear. An inner wall of the shaft hole of the gear in the planetary gear is provided with a helical groove to store lubricant. One end of the output shaft is fixedly connected with a side of the planetary gear away from the planet carrier. The other end of the output shaft is fixedly connected with the drill rod assembly 30 to drive the drill rod assembly 30.

Please refer to FIG. 4 through FIG. 6. In another embodiment, the transmission mechanism includes a first sun gear, a first planetary gear assembly, a second sun gear, a second planetary gear assembly and an inner ring gear. The first planetary gear assembly includes a first planetary gear 491 and a first planet carrier 494. A plurality of first gear shafts 495 are arranged on a side of the first planet carrier 494, and the plurality of the first gear shafts 495 are evenly arranged along a periphery of the first planet carrier 494. The first planetary gear 491 is sleeved on the first gear shaft 495. The first sun gear 493 and the first planetary gear 491 are located in the inner ring gear 492, and the first planetary gear 491 meshes with the inner ring gear 492 and the first sun gear 493. In the embodiment, the first planetary gear 491 includes at least two sets. The at least two sets of the first planetary gears 491 are arranged and overlapped in an axial direction of the inner ring gear 492, which means that the at least two sets are both arranged on the first gear shaft 495. Each set of the first planetary gears 491 includes a plurality of gears, and the plurality of gears are evenly distributed and arranged around the first sun gear 493 and are located on the same level. In some embodiments, the number of gears in each set of the first planetary gears 491 is four. In the embodiment, the first planetary gear 491 is located between the first sun gear 493 and the inner ring gear 492, and meshes with the first sun gear 493 and the inner ring gear 492 for transmission, so that a load borne by the first planetary wheel 491 is relatively uniform, and the first planet carrier 494 can bear a relatively large load and provide a stable output. In the embodiment, the first sun gear 493 is fixedly connected with the motor output shaft of the driving motor 41, or the first sun gear 493 and the motor output shaft of the driving motor 41 are integrally formed. In the embodiment, a helical groove 401 is arranged on an inner wall of the shaft hole of the first planetary gear 491 to store lubricant, so as to increase a duration life of the transmission structure, and to avoid affecting a positioning accuracy of the planetary gear due to an increase of the fit clearance.

Please refer to FIG. 4 through FIG. 7. In the embodiment, the second planetary gear assembly is located below the first planetary gear assembly, and the second planetary gear assembly and the first planetary gear assembly are on the same axis, so as to improve an accuracy of transmission. The second planetary gear assembly includes a second planetary gear 496 and a second planet carrier 498. The second sun gear 497 is fixed on a bottom of the first planet carrier 498, which means that the second sun gear 497 is fixedly connected with a side of the first planet carrier 498 away from the first gear shaft 495. The second planetary gear 496 is arranged on a side of the second planet carrier 498. In an embodiment, a plurality of second gear shafts 499 are arranged on one side of the second planet carrier 498. The plurality of the second gear shafts 499 are evenly arranged on the second planet carrier 498 in a circumferential direction, and the output shaft 45 is fixedly connected with a side of the second planet carrier 498 away from the second gear shaft 499. The output shaft 45 is used to connect with the drill rod assembly 30. The output shaft 45 is fixedly connected or integrally formed with the second planet carrier 498. In this embodiment, the number of gears in the second planetary gear 496 is five. The gears are evenly arranged around the second sun gear 497 and on the same level as the second sun gear. And the gears mesh with the inner ring gear 492 and the second sun gear 497 for transmission, so that a load on the second planetary gear 496 is relatively uniform, and the second planet carrier 498 can bear a relatively large load and form a stable output. In this embodiment, a counterbore 451 is arranged on an end of the output shaft 45 connected with the second planet carrier 498. The counterbore 451 is located on the same axis as central holes of the first planet carrier 494 and the second planet carrier 498. Diameters of the central holes of the first planet carrier 494 and the second planet carrier 498 are the same as a diameter of the counterbore 451. The counterbore 451 is provided with a positioning pin 452. An end of the positioning pin 452 protrudes out of the counterbore 452 and extends into the central holes of the first planet carrier 494 and the second planet carrier 498 to ensure that the first planet carrier 494, the second planet carrier 498 and the output shaft 45 rotate coaxially. In this embodiment, the second planet carrier 498 and the output shaft 45 may be integrally formed, so as to further ensure the accuracy in the transmission process. In this embodiment, a helical groove 401 is arranged on an inner wall of the shaft hole of the second planetary gear 496 to store lubricant, so as to increase a duration life of the transmission structure, and to avoid affecting a positioning accuracy of the planetary gear due to an increase of the fit clearance.

The disclosure provides the gear assembly, the transmission mechanism and the electric drill. A plurality of gears are arranged in the transmission mechanism. Through processing a helical groove in an inner hole of the gears, lubricant may be stored therein so as to increase the duration life of the transmission mechanism. In a heavy-duty transmission structure, this structure improves a lubrication condition. It is also avoided increasing the fit clearance due to a need for lubrication, which will affect the positioning accuracy of the planetary gear, so that the positioning accuracy of the planetary gear is higher.

The above description is only an embodiment of the disclosure and an explanation of the applied technical principles, and those skilled in the art should understand that the scope of the disclosure is not limited to the technical solution formed by the specific combination of the above technical features such as the technical solution formed through the features mentioned above replaced by the technical features disclosed in this disclosure (but not limited to) with similar functions.

Besides the technical features described in the specification, the remaining technical features are known to those skilled in the art which will not be repeated here.

What is claimed is:

1. A transmission mechanism, comprising:
a sun gear, arranged on a motor output shaft of a driving motor,
a planetary gear assembly, comprising a planet carrier and a planetary gear, the planetary gear being arranged on a side of the planet carrier and meshing with the sun gear, a shaft hole being arranged on a gear in the planetary gear, a gear shaft being mounted in the shaft hole, an end of the gear shaft being connected with the planet carrier, and an inner wall of the shaft hole being provided with a helical groove to store lubricant, and
an output shaft, connected with a side of the planetary gear away from the planet carrier.

2. The transmission mechanism according to claim 1, further comprising an inner ring gear, wherein
the planetary gear is located in the inner ring gear and meshes with the inner ring gear.

3. The transmission mechanism according to claim 2, further comprising a gearbox, wherein
the planetary gear assembly and the inner ring gear are located in the gearbox, and the inner ring gear is connected with an inner wall of the gearbox.

4. The transmission mechanism according to claim 1, wherein
one end of the output shaft is fixedly connected with a bottom of the planet carrier, and the other end of the output shaft is connected with a drill rod assembly.

5. The transmission mechanism according to claim 4, wherein
the end of the output shaft connected with the planet carrier is provided with a counterbore, and the counterbore and a center hole of the planet carrier are on a same axis.

6. The transmission mechanism according to claim 5, wherein
a positioning pin is arranged in the counterbore, and an end of the positioning pin protrudes out of the counterbore and extends into the center hole of the planet carrier to ensure a coaxial rotation of the planet carrier and the output shaft.

7. The transmission mechanism according to claim 2, wherein
the sun gear comprises at least a first sun gear and a second sun gear, and the planetary gear assembly comprises at least a first planetary gear assembly and a second planetary gear assembly.

8. The transmission mechanism according to claim 7, wherein
the first sun gear is arranged on the motor output shaft, the first planetary gear assembly is meshed with the first sun gear through a first planetary gear, a bottom of the first planetary gear assembly is connected with the second sun gear, the second planetary gear assembly is meshed with the second sun gear through a second planetary gear, and the output shaft is connected with a bottom of the second planetary gear assembly.

9. The transmission mechanism according to claim 8, wherein
the first planetary gear assembly further comprises at least two sets of first planetary gears, and the at least two sets of the first planetary gears are arranged and overlapped along an axial direction of the inner ring gear.

10. The transmission mechanism according to claim 9, wherein
each set of the first planetary gears comprises a plurality of gears, the plurality of the gears are evenly distributed around the first sun gear and meshed with the first sun gear, and the plurality of the gears are located on a same horizontal plane.

11. The transmission mechanism according to claim 1, wherein
the sun gear is fixedly connected with the motor output shaft of the driving motor or the sun gear and the motor output shaft of the driving motor are integrally formed.

12. An electric drill, comprising:
a supporting assembly, the supporting assembly comprising a supporting plate and a bracket, and the supporting plate being mounted on the bracket;
a handle assembly, arranged on a handle of the bracket;
a driving assembly, arranged on the supporting plate, the driving assembly comprising a driving motor and a transmission mechanism, the transmission mechanism being connected with a motor output shaft of the driving motor, and the transmission mechanism comprising a sun gear, a planetary gear assembly and an output shaft, wherein
the sun gear is arranged on the motor output shaft of the driving motor,
the planetary gear assembly comprises a planet carrier and a planetary gear, the planetary gear is arranged on a side of the planet carrier and meshes with the sun gear, a shaft hole is arranged on a gear in the planetary gear, a gear shaft is mounted in the shaft hole, an end of the gear shaft is connected with the planet carrier, and an inner wall of the shaft hole is provided with a helical groove to store lubricant,
the output shaft is connected with a side of the planetary gear away from the planet carrier; and
a drill rod assembly, connected with the output shaft in the transmission mechanism.

13. A gear assembly, comprising:
a gear, provided with a shaft hole,
a gear shaft, mounted in the shaft hole, wherein
an inner wall of the shaft hole is provided with a helical groove to store lubricant.
